(19) United States
(12) Patent Application Publication
(10) Pub. No.: US 2012/0299808 A1
(43) Pub. Date: Nov. 29, 2012

(54) Image Display Device

(75) Inventors: Guen-Sik LEE, Seoul (KR); Hee-Jin Im, Paju-si (KR); Hyung-Seok Bang, Paju-si (KR)

(73) Assignee: LG Display Co., Ltd.

(21) Appl. No.: 13/332,631

(22) Filed: Dec. 21, 2011

(30) Foreign Application Priority Data
May 25, 2011 (KR) 10-2011-0049821

(51) Int. Cl. G09G 3/36; G02F 1/1334; G02B 5/32

(52) U.S. Cl. 345/102; 359/15; 349/15

(57) ABSTRACT

An image display device which enables tracking of a viewer and is convertible into a 2D display mode without loss of viewing angle, includes an image panel to emit a 2-dimensional (2D) image, a backlight unit to direct collimated light to the image panel, a scattered-light converting cell provided over the backlight unit, the scattered-light converting cell to scatter the collimated light upon 2D display and to directly emit the collimated light upon 3D display, and a holographic optical element provided over the backlight unit, the holographic optical element to adjust an optical path so as to set a viewing window to a position of a viewer upon 3D display.

This application claims the benefit of the Korean Patent Application No. P 10-2011-0049821, filed on May 25, 2011, which is hereby incorporated by reference as if fully set forth herein.

### BACKGROUND OF THE INVENTION

1. Field of the Invention

The present invention relates to an image display device, and more particularly, to an image display device, which enables tracking of a viewer and is convertible into a 2D display mode without loss of viewing angle.

2. Discussion of the Related Art

At present, services for rapid dissemination of information, to be constructed based on high-speed information communication networks, have developed from a simple “listening and speaking” service, such as current telephones, to a “watching and listening” multimedia type service based on digital terminals used for high-speed processing of characters, voices and images, and are expected to be ultimately developed into hyperspace 3-dimensional stereoscopic information communication services enabling virtual reality and stereoscopic viewing free from the restrains of time and space.

In general, stereoscopic images representing 3-dimensions are realized based on the principle of stereo-vision via the viewer's eyes. However, since the viewer's eyes are spaced apart from each other by about 65 mm, i.e. have a binocular parallax, the left and right eyes perceive slightly different images due to a positional difference between the two eyes. Such an image difference due to the positional difference between the two eyes is called binocular disparity. A 3-dimensional stereoscopic image display device is designed based on binocular disparity, allowing the left eye to view only an image for the left eye and the right eye to view only an image for the right eye.

The left and right eyes view different 2-dimensional images, respectively. If the two different images are transmitted to the brain through the retina, the brain accurately combines the images, reproducing depth perception and realism of an original 3-dimensional (3D) image. This ability is conventionally referred to as stereography (stereoscopy), and a display device to which stereoscopy is applied is referred to as a stereoscopic display device.

Stereoscopic display devices may be classified based on methods and characteristics in relation to realization of a 3-dimensional (3D) image. In one example, stereoscopic display devices are classified into glasses-type stereoscopic display devices and non-glasses (glasses free) type stereoscopic display devices. Non-glasses type stereoscopic display devices allow a viewer to see a 3D image without using glasses, and may be classified into binocular disparity type devices and real 3D type devices.

The above described conventional non-glasses type stereoscopic display devices have problems as follows.

In recent non-glasses type stereoscopic display devices, an image has been realized by making several focal images in a multi-view method. However, commercialization of such multi-view type devices is too early because of many drawbacks, such as deterioration in resolution, crosstalk or the like.

The non-glasses type stereoscopic display devices, moreover, cannot provide tracking of a viewer when the viewer is moving and so, there are demands to solve such inability.

If projection of an optimal image is possible in a 3D mode, this may disadvantageously limit a viewing angle upon conversion to a 2D mode. Therefore, demands of image display devices suitable for both 2D and 3D modes are gathering strength.

### SUMMARY OF THE INVENTION

Accordingly, the present invention is directed to an image display device that substantially obviates one or more problems due to limitations and disadvantages of the related art.

An object of the present invention is to provide an image display device, which enables tracking of a viewer and is convertible into a 2D display mode without loss of viewing angle.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an image display device includes an image panel configured to emit a 2-dimensional (2D) image, a backlight unit configured to direct collimated light to the image panel, a scattered-light converting cell provided over the backlight unit, the scattered-light converting cell being configured to scatter the collimated light upon 2D display and to directly emit the collimated light upon 3D display, and a holographic optical element provided over the backlight unit, the holographic optical element being configured to adjust an optical path so as to set a viewing window to a position of a viewer upon 3D display.

The holographic optical element may function as a transparent film upon 2D display.

The backlight unit may include a light source array including a plurality of light sources arranged in a line, each light source being independently turned on or off, and a light guide plate including a thinner proximal side facing the light source array and a distal side opposite to the proximal side, the light guide plate having a vertical cross section, a thickness of which increases away from the proximal side. The distal side of the light guide plate may have a curved surface.

The scattered-light converting cell may include first and second substrates arranged to face each other, a first electrode and a second electrode respectively formed on the first substrate and the second substrate, a plurality of microcapsules, each containing nematic liquid crystals, between the first and second substrates, and a polymer layer filling a space between the first and second substrates except for the plurality of microcapsules.

The image panel may be any one of a liquid crystal panel, an organic light emitting display panel, a quantum-dot light emitting panel, an electric field light emitting display panel and a plasma display panel.

The image panel may be a Spatial Light Modulator (SLM).

The holographic optical element may have a diffraction function upon 3D display. Alternatively, the holographic optical element may have a refraction function upon 3D display.

The scattered-light converting cell and the holographic optical element may be provided above the image panel.

The image display device may further include a tracking unit to track information on the position of the viewer. The information on the position of the viewer may be transmitted to the light source array. The light sources of the light source array may be selectively turned on or off according to the information on the position of the viewer.

All the light sources of the light source array may be turned on upon 2D display.

The light sources may be any one of Light Emitting Diodes (LEDs), Organic Light Emitting Diodes (OLEDs) and laser diodes.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a sectional view illustrating an image display device according to a first embodiment of the present invention;

FIG. 2 is a sectional view illustrating an image display device according to a second embodiment of the present invention;

FIG. 3 is a plan view illustrating a backlight unit for use in the image display device of the present invention;

FIGS. 4A and 4B are sectional views illustrating On/Off operations of a scattered-light converting cell of the image display device according to the present invention;

FIGS. 5A and 5B are sectional views illustrating a 2D viewing mode and a 3D viewing mode of the image display device according to the present invention; and

FIGS. 6A and 6B are views illustrating a viewing window on which a 3D image is formed while a viewer is stationary or while a viewer is moving, in relation to a 3D display mode of the image display device according to the present invention.

### DETAILED DESCRIPTION OF THE INVENTION

Reference will now be made in detail to a stereoscopic display device according to the preferred embodiments of the present invention, examples of which are illustrated in the accompanying drawings. Wherever possible, the same reference numbers will be used throughout the drawings to refer to the same or like parts.

Hereinafter, an image display device according to the present invention will be described in detail with reference to the accompanying drawings.

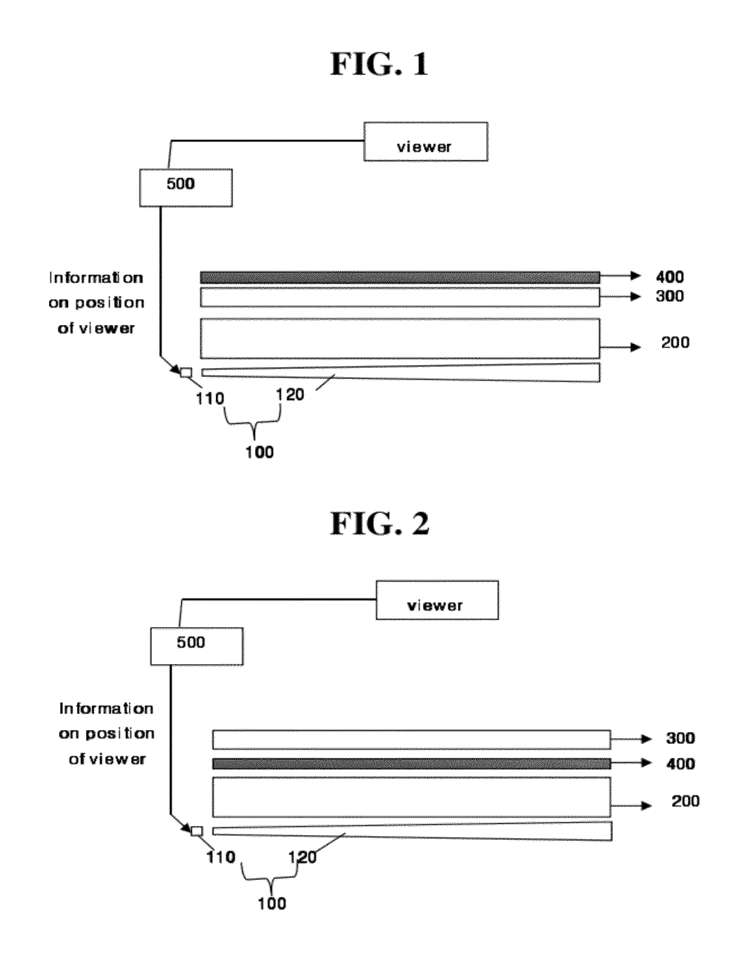

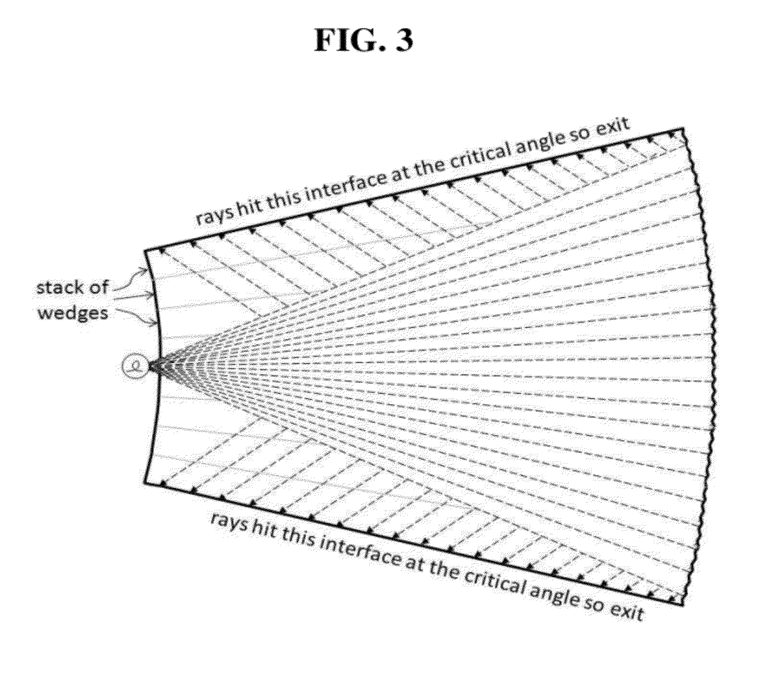

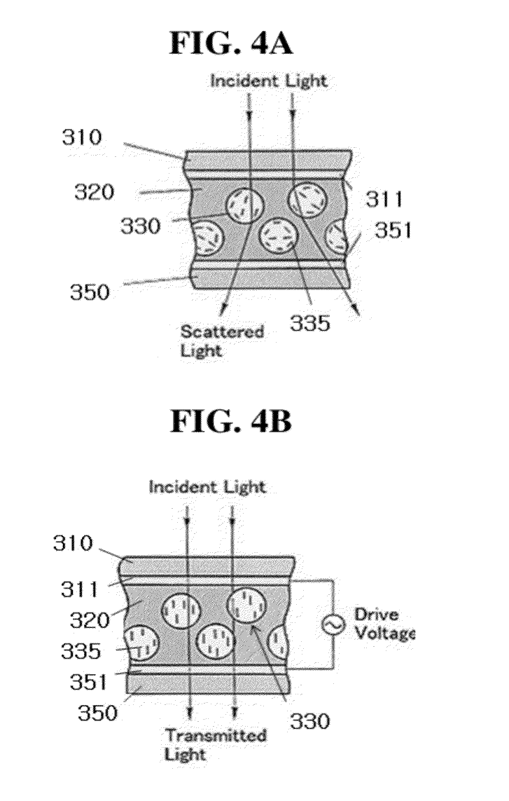

FIG. 1 is a sectional view illustrating an image display device according to a first embodiment of the present invention, and FIG. 2 is a sectional view illustrating an image display device according to a second embodiment of the present invention. Also, FIG. 3 is a plan view illustrating a backlight unit for use in the image display device of the present invention.

As illustrated in FIG. 1, the image display device according to the first embodiment of the present invention is formed by sequentially stacking a backlight unit 100, an image panel 200, a scattered-light converting cell 300 and a holographic optical element 400 one above another from bottom to top.

The image panel 200 emits a 2D image and the backlight unit 100 transmits collimated light toward the image panel 200.

The scattered-light converting cell 300 functions to directly emit collimated light upon 3D display and to scatter collimated light that has passed through the image panel 200 from the backlight unit 100 upon 2D display.

The holographic optical element 400 functions to adjust an optical path so as to set a viewing window to conform to a position of a viewer upon 3D display.

The holographic optical element 400 functions as a transparent film upon 2D display.

The backlight unit 100, referring to FIG. 3, consists of a light source array and a light guide plate 120. The light source array includes a plurality of light sources 110 aligned in a line for transmission of collimated light to the image panel 200 thereabove, and each light source 110 is independently turned on or off. The light guide plate 120 includes a thinner proximal side facing the light source array 110 and a distal side opposite to the proximal side. The light guide plate 120 has a vertical cross section, a thickness of which gradually increases away from the proximal side toward the distal side. This shape is called a wedge shape and is suitable to guide collimated light.

The distal side of the light guide plate 120 is preferably has a curved surface. As occasion demands, likewise, the proximal side of the light guide plate 120 may have a curved surface so as to be parallel to the curved surface of the distal side. The light guide plate 120 may be designed in such a manner that a length of the light guide plate 120 between two non-parallel sides (other sides between the proximal side and the distal side) gradually increases from the proximal side to the distal side. The design requirement of the light guide plate 120 is determined to ensure that light totally reflected within the light guide plate 120 collides with each boundary by a particular angle so as to be transmitted upward as collimated light.

As occasion demands, the light source array may be arranged near the distal side of the light guide plate 120 rather than the proximal side.

The light sources 110 may be any one of Light Emitting Diodes (LEDs), Organic Light Emitting Diodes (OLEDs) and laser diodes. If the light source array is configured such that each of the plurality of light sources is selectively and independently drivable, the light sources may be individually replaced by other light sources.

Each of the scattered-light converting cell 300 and the holographic optical element 400 exhibits different optical functions for 3D display and 2D display. Conversion between the different optical functions may be realized, for example, according to whether voltage is applied or not. Whether to apply voltage or not may be determined by a user selection or by an initial setup value.

The holographic optical element 400 functions to diffract or refract light upon 3D display, causing an image to be formed on a particular viewing window.

For 3D display operation, a tracking unit 500 capable of tracking information on the position of the viewer may be additionally provided, in order to set a viewing window according to the position of the viewer.

Operation of the image display device upon 2D display will now be described.

First, all the light sources 110 of the backlight unit 100 are turned on to emit collimated light from the entire surface of the backlight unit 100. The collimated light is transmitted upward to the image panel 200, the scattered-light converting cell 300 and the holographic optical element 400. In this case, the scattered-light converting cell 300 is in a voltage-off state and causes the incident collimated light to be scattered and emitted to the outside. The holographic optical element 400 above the scattered-light converting cell 300 functions as a transparent from, rather than refracting or diffracting light in a specific direction.

In this case, with the light scattering effects of the scattered-light converting cell 300, it is possible to prevent a viewing window from narrowing despite the use of collimated light having directivity for 3D display. In this case, generally, even a large-scale model, such as a TV, etc., can provide the viewer with a wide viewing window in a 2D mode.

Operation of the image display device upon 3D display is as follows.

First, the tracking unit 500 detects the position of the viewer, stores information on the position of the viewer and transmits the information to the backlight unit 100. Based on the information on the position of the viewer, some of the light sources 110 of the backlight unit 100, which correspond to the position of the corresponding viewer, are turned on.

With selective driving of the light sources 110, collimated light having directivity is emitted upward from the light guide plate 120. Then, the light directly passes through the scattered-light converting cell 300, acting to allow an image to be formed on a particular region, i.e. on a viewer's viewing window while passing through the holographic optical element 400.

The light sources are operable independently even if a plurality of viewers is present and therefore, an image is formed on a viewing window corresponding to each viewer with selective driving of the light sources 110 depending on information on the position of each viewer. More particularly, in the case where a plurality of viewers is present, the viewing window may be provided on a per viewer basis by time division driving or spatial division driving of the light sources based on information on the position of the viewer.

Upon 3D display, the scattered-light converting cell 300 is kept in a voltage-off state and functions as a transparent cell, providing incident light and emitted light with continuity.

Whether to realize 2D display or 3D display as described above depends on selection of a viewer. Alternatively, this may be automatically adjusted according to whether image information applied to the image panel 200 is 2-dimensional information or 3-dimensional information.

The scattered-light converting cell 300, for example, functions as a diffuser such that internal liquid crystals, such as Polymer Dispersed Liquid Crystals (PDLCs), are vertically aligned to emit collimated light when voltage is applied and are randomly distributed when voltage is not applied, thereby exhibiting scattering effects of incident light.

However, the scattered-light converting cell 300 of the present invention is not essentially limited to the PDLCs and may be substituted by other configurations so long as they can achieve switching between 2D display and 3D display according to whether voltage is applied or not and can function to scatter light or function as a transparent cell according to whether voltage is applied or not.

The image panel 200 may be any one of a liquid crystal panel, an organic light emitting display panel, a quantum-dot light emitting panel, an electric field light emitting display panel and a plasma display panel.

In addition to functioning as a display panel, the image panel 200 may function as a Spatial Light Modulator (SML). If the image panel 200 is a spatial light modulator, selective driving of the light sources 110 of the backlight unit 100 and steering of the holographic optical element 400 to a particular viewing window are possible in a 3D mode.

As illustrated in FIG. 2, according to the second embodiment of the present invention, the arrangement of the holographic optical element 400 and the scattered-light converting cell 300 is inverted up and down as compared to the above described first embodiment.

The second embodiment exhibits the same optical effects upon 2D display and 3D display as the first embodiment.

Thus, a description of the same parts as those of the first embodiment will be omitted in relation to the second embodiment.

As occasion demands, the case where the scattered-light converting cell 300 is located below the image panel 200 may be considered. However, according to the kind of the image panel 200, it is necessary to locate the scattered-light converting cell 300 above the image panel 200 without exception.

Hereinafter, the function of the scattered-light converting cell 300 will be described with reference to the drawings.

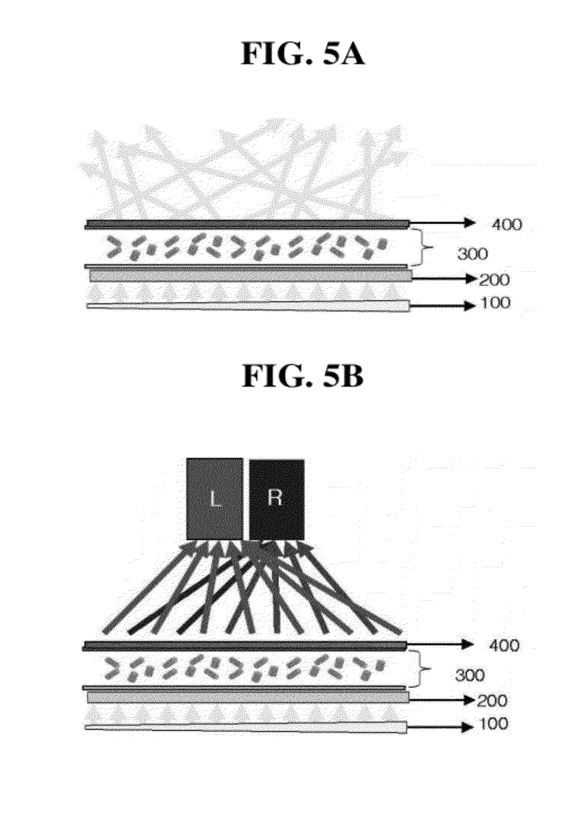

FIGS. 4A and 4B are sectional views illustrating On/Off operations of the scattered-light converting cell of the image display device according to the present invention.

As illustrated in FIG. 4A, the scattered-light converting cell 300 includes first and second substrates 310 and 350 arranged to face each other, a first electrode 311 and a second electrode 351 formed respectively on the first substrate 310 and the second substrate 350, a plurality of microcapsules 330, each containing nematic liquid crystals 335, between the first and second substrates 310 and 350 and a polymer layer 320 filling a space between the first and second substrates 310 and 350 except for the plurality of microcapsules 330.

FIG. 4A illustrates a voltage-off state. During a floating state of the first electrode 311 and the second electrode 351, the nematic liquid crystals 355 within the microcapsules 330 are randomly arranged, which causes incident light to collide with interfaces having different indices of refraction while passing through the microcapsules 330, resulting in emission of scattered light.

FIG. 4B illustrates a voltage-on state. If different voltages are applied to the first electrode 311 and the second electrode 351, the nematic liquid crystals 335 in the polymer layer 320 are erected, which causes incident light to be directly emitted in the same direction as an entrance direction thereof with continuity.

Now, operations in 2D/3D modes using the above described configuration of the scattered-light converting cell will be described.

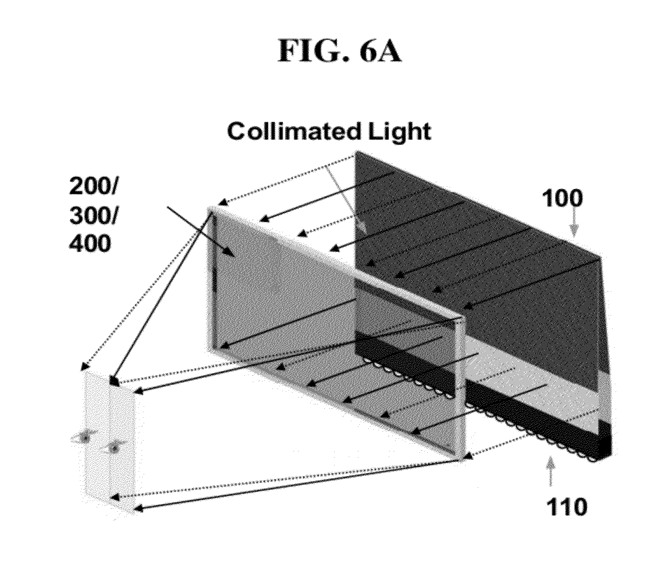

FIGS. 5A and 5B are sectional views illustrating a 2D viewing mode and a 3D viewing mode of the image display device according to the present invention.

As illustrated in FIG. 5A, in the case of a 2D mode, the above described scattered-light converting cell 300 is in a voltage-off state and collimated light introduced into the scattered-light converting cell 300 is emitted as scattered light.

As illustrated in FIG. 5B, in the case of a 3D mode, the nematic liquid crystals 355 are erected within the scattered-light converting cell 300, whereby incident collimated light from the backlight unit 100 is directly emitted as collimated light with continuity. Then, the holographic optical element 400 above the scattered-light converting cell 300 causes images corresponding to the left and right eyes of the viewer to be formed on a corresponding viewing window according to information on the position of the viewer, which enables the viewer to recognize a 3D image.

In the image display device of the present invention, provision of the tracking unit advantageously enables a 3D image to be displayed following movement of a viewer, in addition to displaying a 3D image for a stationary viewer.

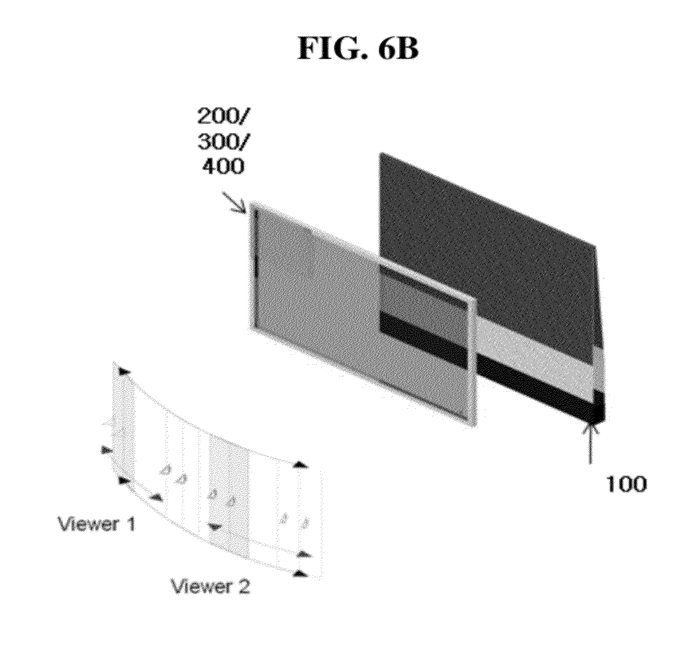

FIGS. 6A and 6B are views illustrating a viewing window on which a 3D image is formed while the viewer is stationary or while the viewer is moving, in relation to a 3D display mode of the image display device according to the present invention.

As illustrated in FIG. 6A, when the viewer is stationary, images corresponding to the left and right eyes of the viewer are formed on an initially set window or on a particular viewing window based on previously stored information on the position of the viewer.

As illustrated in FIG. 6B, if two viewers are present and move respectively in different regions, information on the position of each viewer is transmitted to the light source array of the backlight unit, allowing the light sources at the corresponding positions to be independently driven according to the information on the position of each viewer. In this case, the backlight unit directs collimated light having directivity through the image panel, and the light containing image information, which has passed through the image panel, is introduced into the holographic optical element so as to be diffracted or refracted toward viewing windows of the two viewers, whereby images can be formed on the different viewing windows of the respective viewers.

As is apparent from the above description, an image display device of the present invention has the following effects.

Among conventional non-glasses type devices, in particular, a device in which a holographic optical element is used to form an image at a particular position using collimated light having directivity according to a position of a viewer disadvantageously limits a viewing angle of a viewer in a 2D mode due to the presence of the holographic optical element. The image display device of the present invention further includes a scattered-light converting cell capable of being switched to emit scattered light or collimated light according to whether voltage is applied or not, which can eliminate the limited viewing angle in a 2D mode caused by the holographic optical element.

Moreover, with provision of a tracking unit and a wedge-shaped backlight unit enabling selective division driving of light sources in a 3D mode, it is possible to form a 3D image on a desired viewing window by tracking the position of the viewer. As a result, even if a plurality of viewers is present or even if the viewer moves, display of a vivid 3D image can be realized following movement of the viewer.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. An image display device comprising:
an image panel configured to emit a 2-dimensional (2D) image;
a backlight unit configured to direct collimated light to the image panel;
a scattered-light converting cell over the backlight unit, the scattered-light converting cell being configured to scatter the collimated light upon 2D display and to directly emit the collimated light upon 3D display; and
a holographic optical element over the backlight unit, the holographic optical element being configured to adjust an optical path so as to set a viewing window to a position of a viewer upon 3D display.

2. The image display device according to claim 1, wherein the holographic optical element functions as a transparent film upon 2D display.

3. The image display device according to claim 1, wherein the backlight unit includes:
a light source array including a plurality of light sources arranged in a line, each light source being independently turned on or off; and
a light guide plate including a thinner proximal side facing the light source array and a distal side opposite to the proximal side, the light guide plate having a vertical cross section, a thickness of which increases away from the proximal side.

4. The image display device according to claim 3, wherein the distal side of the light guide plate has a curved surface.

5. The image display device according to claim 1, wherein the scattered-light converting cell includes:
first and second substrates arranged to face each other;
a first electrode and a second electrode respectively formed on the first substrate and the second substrate;
a plurality of microcapsules, each containing nematic liquid crystals, between the first and second substrates; and
a polymer layer filling a space between the first and second substrates except for the plurality of microcapsules.

6. The image display device according to claim 1, wherein the image panel is any one of a liquid crystal panel, an organic light emitting display panel, a quantum-dot light emitting panel, an electric field light emitting display panel and a plasma display panel.

7. The image display device according to claim 1, wherein the image panel is a Spatial Light Modulator (SLM).

8. The image display device according to claim 1, wherein the holographic optical element has a diffraction function upon 3D display.

9. The image display device according to claim 1, wherein the holographic optical element has a refraction function upon 3D display.

10. The image display device according to claim 1, wherein the scattered-light converting cell and the holographic optical element are provided above the image panel.

11. The image display device according to claim 3, further comprising a tracking unit to track information on the position of the viewer.

12. The image display device according to claim 11, wherein the information on the position of the viewer is transmitted to the light source array.

13. The image display device according to claim 12, wherein the light sources of the light source array are selectively turned on or off according to the information on the position of the viewer.

14. The image display device according to claim 3, wherein all the light sources of the light source array are turned on upon 2D display.

15. The image display device according to claim 3, wherein the light sources are any one of Light Emitting Diodes (LEDs), Organic Light Emitting Diodes (OLEDs) and laser diodes.
